(19) United States
(12) Patent Application Publication
(10) Pub. No.: US 2012/0049717 A1
(43) Pub. Date: Mar. 1, 2012

(54) Lamp structure having heat dissipating module

(76) Inventor: Ching-Tung Lu, Banciao City (TW)

(21) Appl. No.: 12/923,014

(22) Filed: Aug. 30, 2010

(51) Int. Cl. H01J 61/52

(52) U.S. Cl. 313/46

(57) ABSTRACT

The present invention is to provide a lamp structure, which includes a lamp housing having a receiving space forming therein, a heat dissipating module connected to one side of the lamp housing, received in the receiving space and having two opposite sides each formed with an opening and a taper hole formed between the two openings, and a cup lamp having one side provided with at least one LED and an opposite side provided with a heat dissipating structure. The heat dissipating structure of the cup lamp is configured to fit in the taper hole of the heat dissipating module and contact with the heat dissipating module, so as to allow heat generated by the cup lamp to be conducted rapidly to the heat dissipating module via the heat dissipating structure, and effectively reduce overall temperature of the cup lamp and prolong service life of the cup lamp.

### FIELD OF THE INVENTION

The present invention relates to a lamp structure, more particularly to a lamp structure including a lamp housing having a heat dissipating module. The lamp housing is formed with a receiving space for receiving a cup lamp and enabling a heat dissipating structure of the cup lamp to contact with the heat dissipating module of the lamp structure, so as to allow heat generated by the cup lamp to be conducted rapidly to the heat dissipating module via the heat dissipating structure and then effectively reduce overall temperature of the cup lamp and therefore prolong service life of the cup lamp.

### BACKGROUND OF THE INVENTION

With the advancement of light-emitting diode (LED) technology, and due to the fact that LEDs have low power consumption and long service life, are free of toxic substances (e.g., mercury), and therefore meet environmental standards, a great variety of lamps (e.g., cup lamps, desk lamps, fluorescent lamps, etc.) have used LEDs as the main light source. As LEDs generate significant heat during light emission, heat dissipation is critical to all LED lamps.

The amount of heat generated by LEDs during operation depends on overall light emission efficiency. Generally speaking, when electricity is applied to an LED, electrons and holes in the LED combine with one another in the depletion layer, and during the combination process, energy is generated and released in the form of light. However, some of the energy is converted into heat, thereby increasing the temperature of the LED chip significantly and compromising the overall light emission efficiency. Therefore, an effort to increase the light emission efficiency of an LED is bound to result in an increase in the heat generated, which accelerates the aging of components around the LED. To dissipate heat from a lamp using LEDs, one conventional approach is to add a heat dissipating structure for rapidly removing heat generated by the LEDs, as explained below with reference to a common LED lamp by way of example. Referring to FIG. 1, a lamp 1 (e.g. a recessed lamp) includes a heat dissipating module 11, an LED circuit board 13, and a lamp housing 15. The heat dissipating module 11 is circumferentially provided with a plurality of heat-dissipating fins 111 for rapid heat dissipation. The LED circuit board 13 is provided with a plurality of LEDs 131 and coupled to one side of the heat dissipating module 11 so as for heat generated by the LEDs 131 to be transmitted directly to the heat dissipating module 11. The lamp housing 15 defines a receiving space 150 therein and has a first side centrally formed with a first opening 151 and a second side centrally formed with a second opening 152. The aforesaid side of the heat dissipating module 11 is connected to a rim of the lamp housing 15 that is adjacent to the second opening 152, such that the LEDs 131 correspond in position to the receiving space 150 and that light emitted by the LEDs 131 is allowed to project out of the lamp housing 15 through the first opening 151. Thus, the lamp 1 can be installed in a ceiling or elsewhere to provide the desired lighting effect, with the heat dissipating module 11 directly dissipating the heat generated by the LEDs 131 and thereby substantially increasing the service life of the lamp 1.

Nevertheless, the lamp 1 still has many drawbacks in use. Referring again to FIG. 1, as the LED circuit board 13 and the lamp housing 15 are both screwed to the heat dissipating module 11, and the LED circuit board 13 is connected with wires, it is impossible for a user to disassemble the lamp 1 by himself/herself. In other words, the design of the lamp 1 does not allow the LED circuit board 13 to be replaced alone when damaged, even if the heat dissipating module 11 and the lamp housing 15 are still in good condition. Therefore, should the LED circuit board 13 be damaged, the user has no choice but to discard the entire lamp 1 and buy a new one, which is a waste of resources and may be a financial burden to the user. Moreover, if light of different brightnesses or colors is desired on a special occasion (e.g., at a party on New Year's Day, Mother's Day, etc.), different lamps 1 must be bought and put in different places, for it is difficult to remove the existing lamp 1 (e.g., recessed lamp). The additional lamps 1 not only take up a lot of space but also incur extra costs.

Hence, it is an important subject for lamp designers and manufacturers to solve the foregoing problems effectively and improve the design of the conventional LED lamp structure with a view to increasing market competitiveness.

### BRIEF SUMMARY OF THE INVENTION

In order to effectively overcome the aforementioned drawbacks of the conventional LED lamp structure, the inventor of the present invention conducted extensive research and experiment and finally succeeded in developing a lamp structure having a heat dissipating module as disclosed herein.

It is an object of the present invention to provide a lamp structure having a heat dissipating module, wherein the lamp structure includes a lamp housing and a cup lamp in addition to the heat dissipating module. The lamp housing has two opposite sides formed with openings that communicate with each other, thereby forming a receiving space in the lamp housing. The heat dissipating module is connected to one side of the lamp housing and has two opposite sides each formed with an opening. The two openings of the heat dissipating module are of different sizes, with a taper hole formed therebetween. The heat dissipating module has a rim formed with a plurality of heat-dissipating fins. Besides, a shoulder is provided on one side of the heat dissipating module and adjacent to the opening formed on that side. The cup lamp has one side provided with at least one LED and an opposite side provided with a conduction portion. In addition, the cup lamp is peripherally provided with a heat dissipating structure. The cup lamp is configured to fit in the taper hole of the heat dissipating module through the opening to which the shoulder is adjacent, such that the conduction portion is electrically connected to a power connector and that a rim of the cup lamp that is adjacent to the side provided with the at least one LED is pressed against the shoulder, thus allowing heat generated by the cup lamp to be conducted rapidly to the heat dissipating module. The lamp structure of the present invention can effectively reduce the overall temperature of the cup lamp and therefore has a long service life.

It is another object of the present invention to provide the foregoing lamp structure, wherein the cup lamp can be conveniently replaced by the user. Hence, the cup lamp, when damaged, can be replaced alone without having to disassemble the entire lamp structure. Since the lamp housing and the heat dissipating module need not be replaced, the costs incurred are much lower than if the entire lamp structure has to be discarded.

### BRIEF DESCRIPTION OF THE SEVERAL VIEWS OF THE DRAWINGS

The invention as well as a preferred mode of use, further objects, and advantages thereof will be best understood by referring to the following detailed description of some preferred embodiments in conjunction with the accompanying drawings, in which:

FIG. 1 is an exploded perspective view of a conventional LED lamp;

FIG. 2 is an exploded perspective view of a lamp structure according to a first preferred embodiment of the present invention;

FIG. 3 is an exploded, partially sectional view of the lamp structure shown in FIG. 2;

FIG. 4 is an assembled, partially sectional view of the lamp structure shown in FIG. 2; and

FIG. 5 is an exploded, partially sectional view of a lamp structure according to a second preferred embodiment of the present invention.

### DETAILED DESCRIPTION OF THE INVENTION

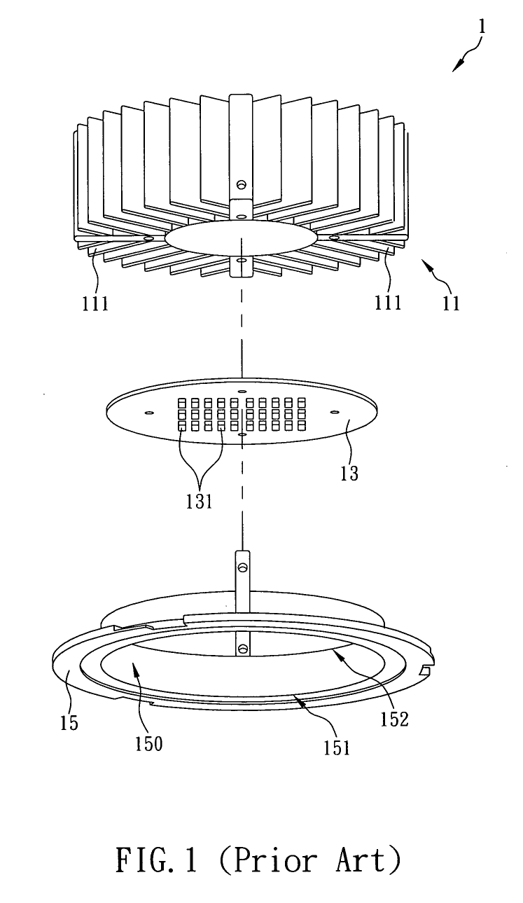

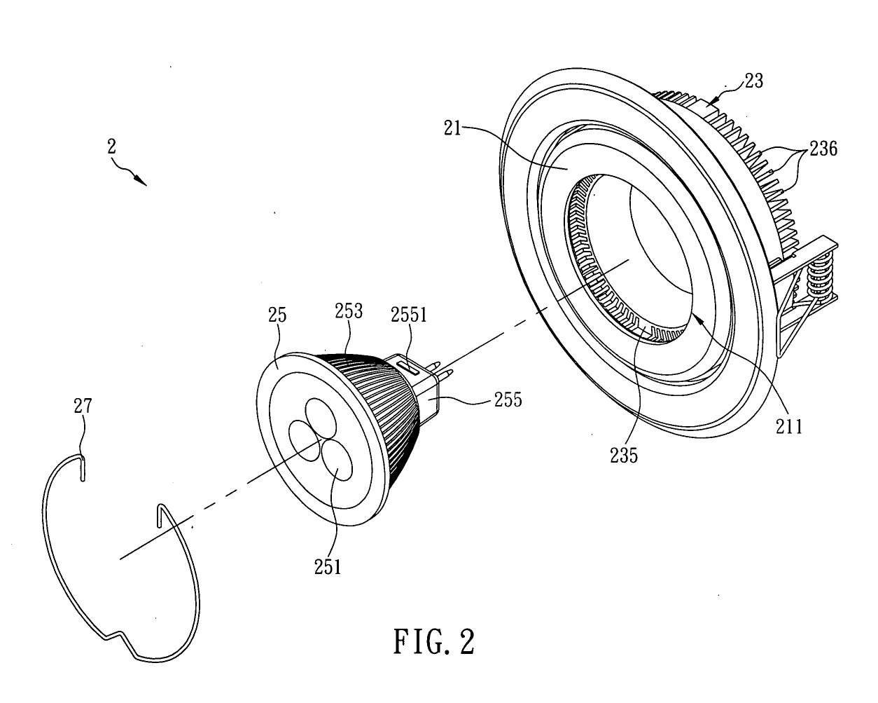

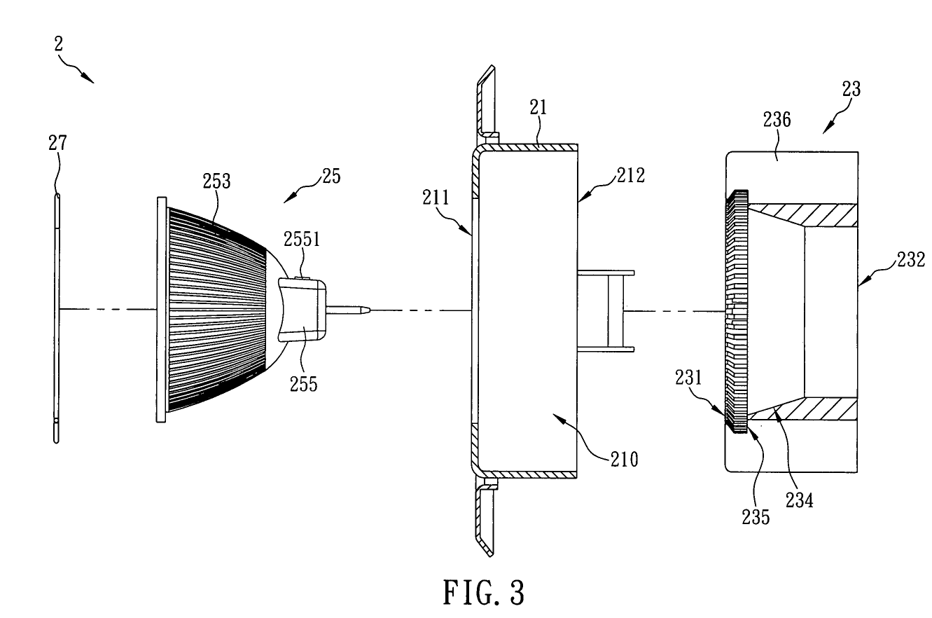

The present invention relates to a lamp structure having a heat dissipating module, wherein the lamp structure features rapid dissipation of heat from a cup lamp and easy substitution of different cup lamps so as to provide convenience of use and have a long service life. Referring to FIGS. 2 and 3, in a first preferred embodiment of the present invention, a lamp structure 2 includes a lamp housing 21, a heat dissipating module 23, and a cup lamp 25. The lamp housing 21 defines a receiving space 210 therein and has a first side centrally formed with a first opening 211 and a second side centrally formed with a second opening 212. The second opening 212 corresponds in position to and is larger than the first opening 211. In a different embodiment of the present invention, however, the shape of the lamp housing 21 may vary as needed and is not limited to that described above. For instance, the first opening 211 may be larger than the second opening 212, as with the lamp housing 15 shown in FIG. 1. Besides, when the lamp housing 21 has a special configuration, the first opening 211 and the second opening 212 may be provided at positions that are not at the center of the lamp housing 21. The heat dissipating module 23 is integrally formed by an aluminum extrusion process and configured to fit into the second opening 212 on the second side of the lamp housing 21. In the present embodiment, the heat dissipating module 23 is installed in the receiving space 210 through the second opening 212 such that a rim of the heat dissipating module 23 is pressed against an inner edge of the lamp housing 21 that is adjacent to the first opening 211. The heat dissipating module 23 has a first side centrally formed with a third opening 231 and a second side centrally formed with a fourth opening 232, wherein the third opening 231 corresponds in position to and is smaller than the first opening 211, and the fourth opening 232 corresponds in position to and is smaller than the third opening 231. A taper hole 234 is formed between the third opening 231 and the fourth opening 232, wherein the depth of the taper hole 234 may vary as needed. A shoulder 235 is formed on the first side of the heat dissipating module 23 and adjacent to the third opening 231. In addition, a plurality of heat-dissipating fins 236 are formed around the aforesaid rim of the heat dissipating module 23. The heat-dissipating fins 236 enable rapid dissipation of heat from the heat dissipating module 23 and thus increase heat dissipation efficiency thereof.

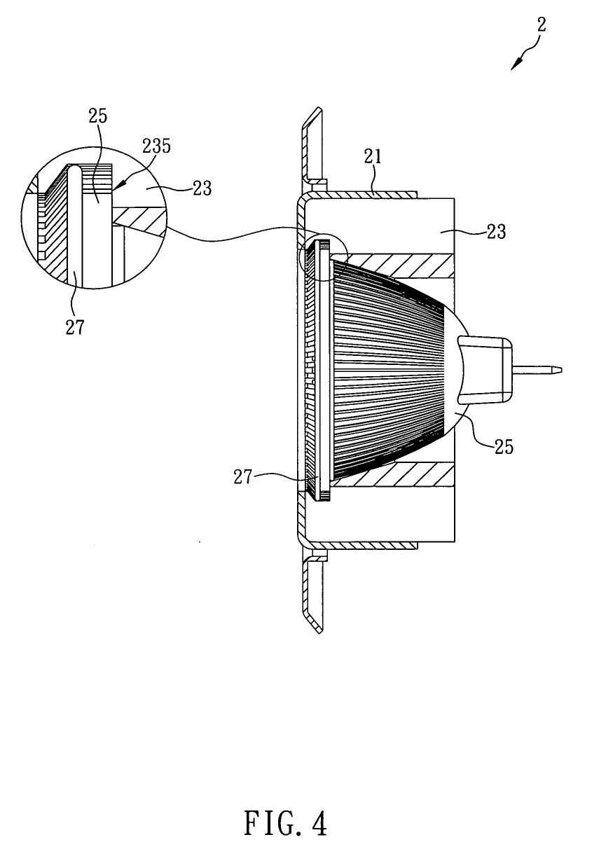

As shown in FIGS. 2 and 3, the cup lamp 25 has a first side provided with at least one LED 251 and is peripherally provided with a heat dissipating structure 253 for dissipating heat generated by the LEDs 251. Also, the cup lamp 25 has a second side which is opposite the first side of the cup lamp 25 and provided with a conduction portion 255. The cup lamp 25 as a whole has a cup shape and can fit into the taper hole 234 through the first opening 211 and the third opening 231 sequentially so as for the conduction portion 255 to connect electrically with a power connector (not shown). With reference to FIG. 4, when the cup lamp 25 is received in the taper hole 234, a rim of the cup lamp 25 that is adjacent to the first side of the cup lamp 25 is pressed against the shoulder 235, such that heat generated by the LEDs 251 of the cup lamp 25 is conducted rapidly via the heat dissipating structure 253 to the heat dissipating module 23, which has a larger volume and consequently is more efficient in heat dissipation than the heat dissipating structure 253. As a result, the overall temperature of the cup lamp 25 is significantly lowered, and the service life of the cup lamp 25 extended. In a different embodiment of the present invention, the cup lamp 25 conforms in shape to the taper hole 234, thus allowing the heat dissipating structure 253 of the cup lamp 25 to be in close contact with the surface of the taper hole 234 to effectively enhance heat dissipation from the cup lamp 25. Thus, the user may install a high-brightness cup lamp 25 into the lamp housing 21 and the heat dissipating module 23 without worrying that the cup lamp 25 may burn due to the otherwise high temperature.

As shown in FIGS. 3 and 4, the lamp structure 2 further includes a pressing element 27. The pressing element 27 is a resilient metal ring configured to fit into the receiving space 210 of the lamp housing 21 and press against the first side of the cup lamp 25, thereby preventing the cup lamp 25 from falling off the lamp housing 21. In a different embodiment of the present invention, however, the pressing element 27 may have a different shape as required by design and be provided directly on the lamp housing 21. Alternatively, a positioning element 2551 (e.g., a rib or groove) is provided on the conduction portion 255 of the cup lamp 25 so as for the cup lamp 25 to engage with the power connector, thus effectively increasing the industrial applicability and market competitiveness of the present invention. When the cup lamp 25 is damaged after long-term use, the user only has to buy a new cup lamp 25 and install it in the lamp housing 21 and the heat dissipating module 23. As the cost of buying the cup lamp 25 is far lower than that of buying the entire lamp structure 2, which includes the lamp housing 21, the heat dissipating module 23, and the cup lamp 25, the user is spared the extra expenses. Furthermore, as the lamp housing 21 and the heat dissipating module 23 of the lamp structure 2 can be used with different cup lamps 25, the user can replace the existing cup lamp 25 with cup lamps 25 of different colors or brightnesses according to the needs of specific occasions, without having to replace the lamp housing 21 and the heat dissipating module 23. Thus, not only is a waste of resources avoided, but also the convenience of use of the lamp structure 2 is substantially increased.

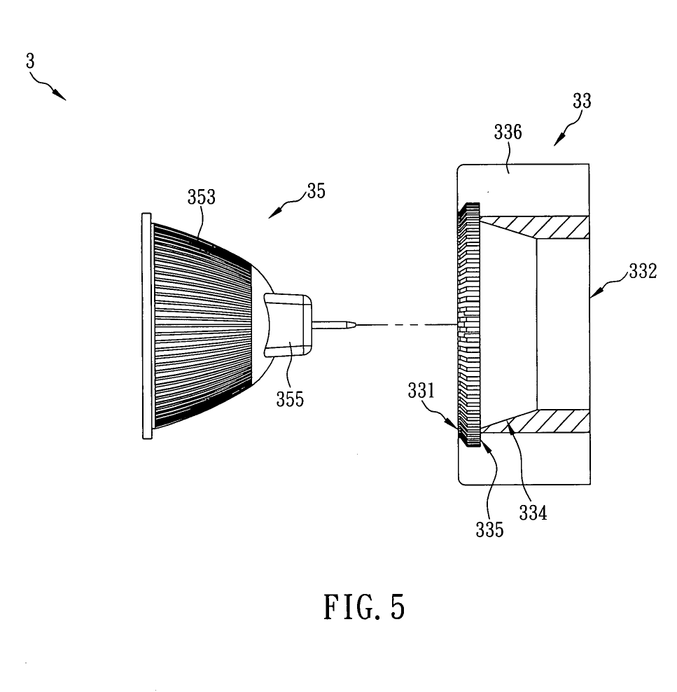

FIG. 5 shows a second preferred embodiment of the present invention, wherein a lamp structure 3 (shown as a track lamp) includes a heat dissipating module 33 and a cup lamp 35. The heat dissipating module 33 is configured to be installed in a track lamp frame (not shown) and has opposite first and second sides which are formed with a third opening 331 and a fourth opening 332, respectively, wherein the third opening 331 is larger than the fourth opening 332. Besides, a taper hole 334 is formed between the third opening 331 and the fourth opening 332. The heat dissipating module 33 has a rim formed with a plurality of heat-dissipating fins 336. The heat dissipating module 33 also has a shoulder 335 formed on the first side and located adjacent to the third opening 331. The cup lamp 35 has a first side provided with at least one LED and a second side provided with a conduction portion 355. In addition, the cup lamp 35 is peripherally provided with a heat dissipating structure 353. The cup lamp 35 is configured to fit into the taper hole 334 through the first opening 331 of the heat dissipating module 33 so as to be inserted in the heat dissipating module 33. When the cup lamp 35 is received in the taper hole 334, the conduction portion 355 is electrically connected to a power connector, and a rim of the cup lamp 35 that is adjacent to the first side is pressed against the shoulder 335, allowing heat generated by the cup lamp 35 to be conducted rapidly to the heat dissipating module 33. As the structure of the present invention enables rapid dissipation of heat from the cup lamp 35, manufacturers may use cup lamps 35 of high light emission efficiency. For instance, when the conventional LED lamp structure is used, it is necessary to use a plurality of cup lamps, each with a power of, say, 3 W, to achieve a predetermined brightness. By contrast, when the lamp structure 3 of the present invention is used, the predetermined brightness can be achieved by directly using a 6 W or 12 W cup lamp 35. Hence, not only is the space required for component arrangement in the lamp structure reduced, but also a waste of resources is prevented.

It should be particularly pointed out that, while the lamp structure in the first preferred embodiment includes the cup lamp, the lamp structure of the present invention may include only the lamp housing and the heat dissipating module. In the latter case, the cup lamp is bought by the user separately and then installed in the lamp structure. According to the above description, the lamp structure of the present invention allows substitution of different cup lamps by the user himself/herself and therefore provides convenient of use. Also, the heat dissipating structure on the cup lamp and the heat dissipating module of the lamp structure effectively increase the overall heat dissipation efficiency, and hence extend the service life, of the lamp structure. Besides, when the cup lamp is damaged, the user can replace only the cup lamp without having to replace the entire lamp structure, and consequently the costs incurred are reduced.

While the present invention is described herein with reference to the preferred embodiments, it is understood that the embodiments are not intended to limit the scope of the present invention. Therefore, all equivalent changes that are based on the technical content disclosed herein and easily conceivable by a person skilled in the art should fall within the scope of the present invention, which is defined only by the appended claims.

What is claimed is:

1. A lamp structure having a heat dissipating module, the lamp structure comprising:
a lamp housing defining a receiving space therein and having a first side formed with a first opening and a second side formed with a second opening;
the heat dissipating module inserted through the second opening and having a first side centrally formed with a third opening and provided with a shoulder adjacent to the third opening, wherein the third opening corresponds in position to and is smaller than the first opening; and a second side centrally formed with a fourth opening, wherein the fourth opening corresponds in position to and is smaller than the third opening; and a rim formed with a plurality of heat-dissipating fins; thereby a taper hole is formed between the third opening and the fourth opening; and
a cup lamp having a first side provided with at least a light-emitting diode (LED), a rim adjacent to the first side thereof, and a second side which is opposite the first side thereof and provided with a conduction portion, the cup lamp being peripherally provided with a heat dissipating structure and configured to fit in the taper hole through the third opening such that the conduction portion is electrically connected to a power connector and that the rim of the cup lamp is pressed against the shoulder.

2. The lamp structure of claim 1, wherein the second opening corresponds in position to and is larger than the first opening, and the rim of the heat dissipating module is pressed against an inner edge of the lamp housing that is adjacent to the first opening.

3. The lamp structure of claim 1, further comprising a pressing element formed as a resilient metal ring, wherein the pressing element is configured to fit tightly in the receiving space of the lamp housing at a position adjacent to the first opening and press against the first side of the cup lamp.

4. The lamp structure of claim 2, further comprising a pressing element formed as a resilient metal ring, wherein the pressing element is configured to fit tightly in the receiving space of the lamp housing at a position adjacent to the first opening and press against the first side of the cup lamp.

5. The lamp structure of claim 1, wherein the conduction portion of the cup lamp is provided with a positioning element for engaging with the power connector.

6. The lamp structure of claim 2, wherein the conduction portion of the cup lamp is provided with a positioning element for engaging with the power connector.

7. The lamp structure of claim 5, wherein the first opening is centrally formed on the first side of the lamp housing, and the second opening is centrally formed on the second side of the lamp housing.

8. The lamp structure of claim 6, wherein the first opening is centrally formed on the first side of the lamp housing, and the second opening is centrally formed on the second side of the lamp housing.

9. A lamp structure having a heat dissipating module, the lamp structure comprising:
a lamp housing defining a receiving space therein and having a first side formed with a first opening and a second side formed with a second opening; and
the heat dissipating module inserted through the second opening and having a first side centrally formed with a third opening and provided with a shoulder adjacent to the third opening, wherein the third opening corresponds in position to and is smaller than the first opening; a second side centrally formed with a fourth opening, wherein the fourth opening corresponds in position to and is smaller than the third opening; and a rim formed with a plurality of heat-dissipating fins; thereby a taper hole is formed between the third opening and the fourth opening, and the taper hole is configured to receive a cup lamp inserted through the third opening such that a rim of the cup lamp that is adjacent to a side of the cup lamp is pressed against the shoulder.

10. The lamp structure of claim 9, wherein the second opening corresponds in position to and is larger than the first opening, and the rim of the heat dissipating module is pressed against an inner edge of the lamp housing that is adjacent to the first opening.

11. The lamp structure of claim 10, wherein the first opening is centrally formed on the first side of the lamp housing, and the second opening is centrally formed on the second side of the lamp housing.

12. A lamp structure having a heat dissipating module, the lamp structure comprising:
the heat dissipating module having a first side centrally formed with a third opening and provided with a shoulder adjacent to the third opening; a second side centrally formed with a fourth opening, wherein the fourth opening corresponds in position to and is smaller than the third opening; and a rim formed with a plurality of heat-dissipating fins; thereby a taper hole is formed between the third opening and the fourth opening; and
a cup lamp having a first side provided with at least a light-emitting diode (LED) and a rim adjacent to the first side thereof, and a second side which is opposite the first side thereof and provided with a conduction portion, wherein the cup lamp is peripherally provided with a heat dissipating structure and configured to fit in the taper hole through the first opening such that the conduction portion is electrically connected to a power connector and that the rim of the cup lamp is pressed against the shoulder.

13. The lamp structure of claim 12, further comprising a pressing element formed as a resilient metal ring, wherein the pressing element is configured to fit tightly in the third opening of the heat dissipating module and press against the first side of the cup lamp.
